(19) United States
(12) Patent Application Publication
(10) Pub. No.: US 2026/0367404 A1
(43) Pub. Date: Nov. 19, 2026

(54) SAFETY PROTECTION METHOD, ELECTRONIC DEVICE, AND SMART GLASSES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHENG-CHING CHIEN, New Taipei (TW); Shu-Hao Liu, New Taipei (TW)

(21) Appl. No.: 19/424,380

(22) Filed: Dec. 18, 2025

(30) Foreign Application Priority Data
May 14, 2025 (CN) 202510621723.1

(51) Int. Cl. G02B 27/01; G06T 7/20; G10L 15/26

(52) U.S. Cl. CPC G02B 27/0172; G02B 27/0101; G06T 7/20; G10L 15/26; G02B 2027/0138; G02B 2027/0178; G06T 2207/10028

(57) ABSTRACT

The present application provides a safety protection method, an electronic device, and smart glasses. The safety protection method includes collecting environmental information of the smart glasses in real time through the multi-source sensors. Whether a wearer of the smart glasses is in a predetermined safety condition is determined based on the environmental information. If the wearer is in the predetermined safety condition, a category of the predetermined safety condition is determined, and a protective measure corresponding to the category is executed. The present application enables the smart glasses to achieve danger prediction and intervention while ensuring an immersive experience.

### TECHNICAL FIELD

The present application relates to a technical field of smart glasses, and specifically relates to a safety protection method, an electronic device, and smart glasses.

### BACKGROUND ART

With a popularization of augmented reality (AR)/mixed reality (MR) devices, users' demand for immersive experiences is increasingly growing. To meet users' demands, AR/MR devices adopt electrochromic lens technology, which actively isolates external light sources (such as sunlight, strong lighting) by adjusting light transmittance, thereby improving a contrast and a visual comfort of virtual content display.

However, while this optical isolation mechanism enhances immersion, it significantly weakens the user's perception ability of a real environment, leading to potential safety risks in dynamic scenes, such as: scenes of moving vehicles, falling objects from heights, slippery ground, or sudden obstacles.

### SUMMARY

In view of the above content, it is necessary to propose a safety protection method, a safety protection device, an electronic device, and smart glasses.

In a first aspect, the present application provides a safety protection method, comprising: collecting environmental information of smart glasses through multi-source sensors of the smart glasses; determining whether a wearer of the smart glasses is in a predetermined safety condition based on the environmental information; and in response that the wearer is in the predetermined safety condition, determining a category of the predetermined safety condition, and executing a protective measure corresponding to the category.

In some embodiments of the present application, the environmental information comprises audio data; wherein determining whether the wearer is in the predetermined safety condition based on the environmental information comprises: converting the audio data into text information, and measuring a volume value of the audio data; in response that the text information includes a preset keyword and/or the volume value being greater than a preset volume threshold, determining that the wearer is in the predetermined safety condition; wherein determining the category of the predetermined safety condition comprises: in response that position information of a sound source relative to the wearer has been determined based on the audio data, determining that the category is a first preset category; in response that the position information cannot be determined based on the audio data, determining that the category is a second preset category.

In some embodiments of the present application, the environmental information comprises image data and 3D point cloud data; wherein determining whether the wearer of the smart glasses is in the predetermined safety condition based on the environmental information comprises: detecting a moving object in the image data based on a preset object perception algorithm; determining a separation distance between the moving object and the smart glasses based on the 3D point cloud data; in response to the separation distance being less than a preset distance threshold, determining that the wearer is in the predetermined safety condition; wherein determining the category of the predetermined safety condition comprises: determining that the category is a first preset category.

In some embodiments of the present application, the environmental information comprises image data and 3D point cloud data; wherein determining whether the wearer of the smart glasses is in the predetermined safety condition based on the environmental information comprises: determining, based on a preset object perception algorithm and by combining the image data and the 3D point cloud data, whether ground on which the wearer is walking has preset hazardous terrain; in response that the ground has the preset hazardous terrain, determining that the wearer is in the predetermined safety condition; wherein determining the category of the predetermined safety condition comprises: determining that the category is a first preset category.

In some embodiments of the present application, the environmental information comprises image data; wherein determining whether the wearer of the smart glasses is in the predetermined safety condition based on the environmental information comprises: detecting whether a preset keyword is in the image data based on a preset target detection algorithm; in response that the preset keyword is in the image data, determining that the wearer is in the predetermined safety condition; wherein determining the category of the predetermined safety condition comprises: determining that the category is a second preset category.

In some embodiments of the present application, the environmental information comprises motion state data of the wearer; wherein determining whether the wearer of the smart glasses is in the predetermined safety condition based on the environmental information comprises: determining a changed amplitude and a changed speed of a movement direction of the wearer based on the motion state data; in response that the changed amplitude is greater than a preset amplitude threshold and/or the changed speed being greater than a preset speed threshold, determining that the wearer is in the predetermined safety condition; wherein determining the category of the predetermined safety condition comprises: determining that the category is a second preset category.

In some embodiments of the present application, the smart glasses further comprise electrochromic lenses, and the executing of the protective measure corresponding to the category comprises: in response that the category is a first preset category, turning off a local tinting mode of the electrochromic lenses, and turning on a local transparent mode of the electrochromic lenses; in response that the category is a second preset category, turning off a global tinting mode of the electrochromic lenses, and turning on a global transparent mode of the electrochromic lenses.

In some embodiments of the present application, the safety protection method further comprises: pausing playback of audio and video after executing the protective measure corresponding to the category.

In a second aspect, the present application provides an electronic device, comprising: a storage device stored with a computer program; and at least one processor; wherein when the computer program is executed by the at least one processor, the at least one processor is caused to: collect environmental information of smart glasses through multi-source sensors of the smart glasses; determine whether a wearer of the smart glasses is in a predetermined safety condition based on the environmental information; and in response that the wearer is in the predetermined safety condition, determine a category of the predetermined safety condition, and execute a protective measure corresponding to the category.

In some embodiments of the present application, the environmental information comprises audio data; wherein the at least one processor determines whether the wearer is in the predetermined safety condition based on the environmental information by: converting the audio data into text information, and measuring a volume value of the audio data; in response to the text information including a preset keyword and/or the volume value being greater than a preset volume threshold, determining that the wearer is in the predetermined safety condition; wherein the at least one processor determines the category of the predetermined safety condition by: in response to position information of a sound source relative to the wearer having been determined based on the audio data, determining that the category is a first preset category; in response to the position information cannot be determined based on the audio data, determining that the category is a second preset category.

In some embodiments of the present application, the environmental information comprises image data and 3D point cloud data; wherein the at least one processor determines whether the wearer of the smart glasses is in the predetermined safety condition based on the environmental information by: detecting a moving object in the image data based on a preset object perception algorithm; determining a separation distance between the moving object and the smart glasses based on the 3D point cloud data; in response to the separation distance being less than a preset distance threshold, determining that the wearer is in the predetermined safety condition; wherein the at least one processor determines the category of the predetermined safety condition by: determining that the category is a first preset category.

In some embodiments of the present application, the environmental information comprises image data and 3D point cloud data; wherein the at least one processor determines whether the wearer of the smart glasses is in the predetermined safety condition based on the environmental information by: determining, based on a preset object perception algorithm and by combining the image data and the 3D point cloud data, whether ground on which the wearer is walking has preset hazardous terrain; in response to the ground having the preset hazardous terrain, determining that the wearer is in the predetermined safety condition; wherein the at least one processor determines the category of the predetermined safety condition by: determining that the category is a first preset category.

In some embodiments of the present application, the environmental information comprises image data; wherein the at least one processor determines whether the wearer of the smart glasses is in the predetermined safety condition based on the environmental information by: detecting whether a preset keyword is in the image data based on a preset target detection algorithm; in response that the preset keyword is in the image data, determining that the wearer is in the predetermined safety condition; wherein the at least one processor determines the category of the predetermined safety condition by: determining that the category is a second preset category.

In some embodiments of the present application, the environmental information comprises motion state data of the wearer; wherein the at least one processor determines whether the wearer of the smart glasses is in the predetermined safety condition based on the environmental information by: determining a changed amplitude and a changed speed of a movement direction of the wearer based on the motion state data; in response to the changed amplitude being greater than a preset amplitude threshold and/or the changed speed being greater than a preset speed threshold, determining that the wearer is in the predetermined safety condition; wherein the at least one processor determines the category of the predetermined safety condition by: determining that the category is a second preset category.

In some embodiments of the present application, the smart glasses further comprise electrochromic lenses, and the at least one processor executes the protective measure corresponding to the category by: in response to the category being a first preset category, turning off a local tinting mode of the electrochromic lenses, and turning on a local transparent mode of the electrochromic lenses; in response to the category being a second preset category, turning off a global tinting mode of the electrochromic lenses, and turning on a global transparent mode of the electrochromic lenses.

In some embodiments of the present application, the at least one processor is further caused to pause playback of audio and video after executing the protective measure corresponding to the category.

In a third aspect, the present application provides smart glasses, wherein the smart glasses comprise the electronic device recited in the first aspect.

### BRIEF DESCRIPTION OF DRAWINGS

FIG. 1 is a schematic diagram of an application scenario of a safety protection method according to an embodiment of the present application.

FIG. 2 is a flowchart of a safety protection method according to an embodiment of the present application.

FIG. 3 is a functional block diagram of a safety protection device according to an embodiment of the present application.

The following detailed description will further explain the present application with reference to the above drawings.

### DETAILED DESCRIPTION

The embodiments of the present application are described in detail below. Examples of the embodiments are shown in the drawings, wherein the same or similar reference numerals throughout indicate the same or similar elements or elements having the same or similar functions. The embodiments described below with reference to the drawings are exemplary and are only used to explain the present application, and should not be construed as limiting the present application.

In the embodiments of the present application, it should be noted that, unless otherwise clearly specified and defined, words such as "for example" are used to indicate examples, illustrations, or explanations. Any embodiment or design solution described as "for example" in the embodiments of the present application should not be interpreted as being more preferred or advantageous than other embodiments or design solutions. Rather, the use of words such as "for example" is intended to present related concepts in a specific manner.

In the description of the present application, it should be noted that, unless otherwise clearly specified and defined, the terms "install", "connect", and "link" should be understood broadly. For example, it may be a fixed connection, a detachable connection, or an integral connection; it may be a mechanical connection, an electrical connection, or allow communication; it may be a direct connection, or an indirect connection through an intermediate medium, and it may be the internal communication between two elements or the interaction relationship between two elements. Those of ordinary skill in the art can understand the specific meanings of the above terms in the present application based on specific situations.

In the description of the present application, it should be noted that, unless otherwise clearly specified and defined, the terms "first", "second" are only used for descriptive purposes, and cannot be understood as indicating or implying relative importance or implicitly indicating the number of indicated technical features. Thus, features defined with "first", "second" may explicitly or implicitly include one or more of the features. Furthermore, in the description of the present application, "multiple" means two or more, unless otherwise clearly and specifically defined.

In order to more clearly understand the above objectives, features, and advantages of the present invention, the present invention is described in detail below with reference to the drawings and specific embodiments. It should be noted that, in the case of no conflict, the embodiments of the present application and the features in the embodiments can be combined with each other.

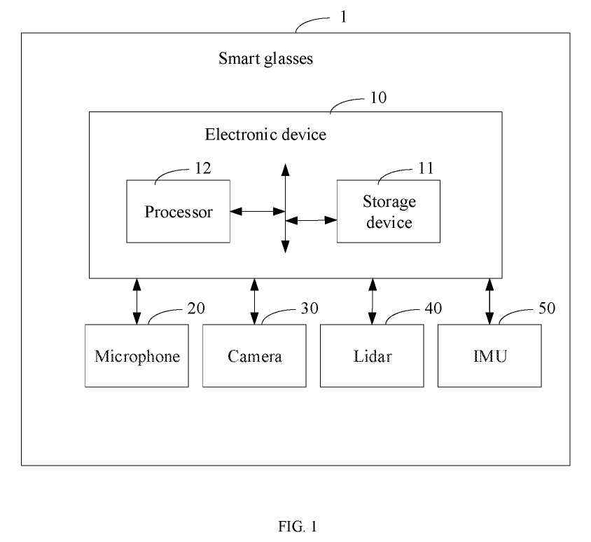

Please refer to FIG. 1, which is a schematic diagram of an application scenario of a safety protection method according to an embodiment of the present application.

The safety protection method provided by the embodiment of the present application is applied to smart glasses 1. The smart glasses 1 include an electronic device 10 and multi-source sensors. The electronic device 10 is in communication connection with the multi-source sensors. The multi-source sensors are used to collect environmental information around the smart glasses 1 and send the collected environmental information to the electronic device 10.

In some embodiments of the present application, the multi-source sensors may include, but are not limited to, at least one microphone 20, at least one camera 30, at least one lidar 40, at least one inertial measurement unit (IMU) 50, etc. The microphone 20 is used to collect audio data, the camera 30 is used to collect image data, the lidar 40 is used to collect three-dimensional (3D) point cloud data, and the IMU 50 is used to calculate motion state data of an object by measuring an acceleration and an angular velocity of the object.

In some embodiments of the present application, the electronic device 10 is a device that can automatically perform numerical calculations and/or information processing according to pre-set or stored instructions. Hardware of the electronic device 10 includes, but is not limited to, microprocessors, application specific integrated circuits (ASIC), field-programmable gate arrays (FPGA), digital signal processors (DSP), embedded devices, etc.

Specifically, the electronic device 10 is used to: collect environmental information of the smart glasses 1 in real time through the multi-source sensors; determine whether a wearer of the smart glasses 1 is in a predetermined safety condition based on the environmental information; if the wearer of the smart glasses 1 is in the predetermined safety condition, determine a category of the predetermined safety condition, and execute a protective measure corresponding to the category.

In some embodiments of the present application, the electronic device 10 can be in communication connection with devices such as a desktop computer, a notebook, a palmtop computer, a cloud server, etc.

In some embodiments of the present application, the electronic device 10 can interact with a user through a keyboard, a mouse, a remote control, a touchpad, or a voice control device, etc.

In some embodiments of the present application, the electronic device 10 may further include a network device and/or a client device. The network device includes, but is not limited to, a single network server, a server group composed of multiple network servers, or a cloud server composed of a large number of hosts or network servers based on cloud computing.

In some embodiments of the present application, the network that the electronic device 10 is connected includes, but is not limited to, the Internet, a wide area network, a metropolitan area network, a local area network, a virtual private network (VPN), etc.

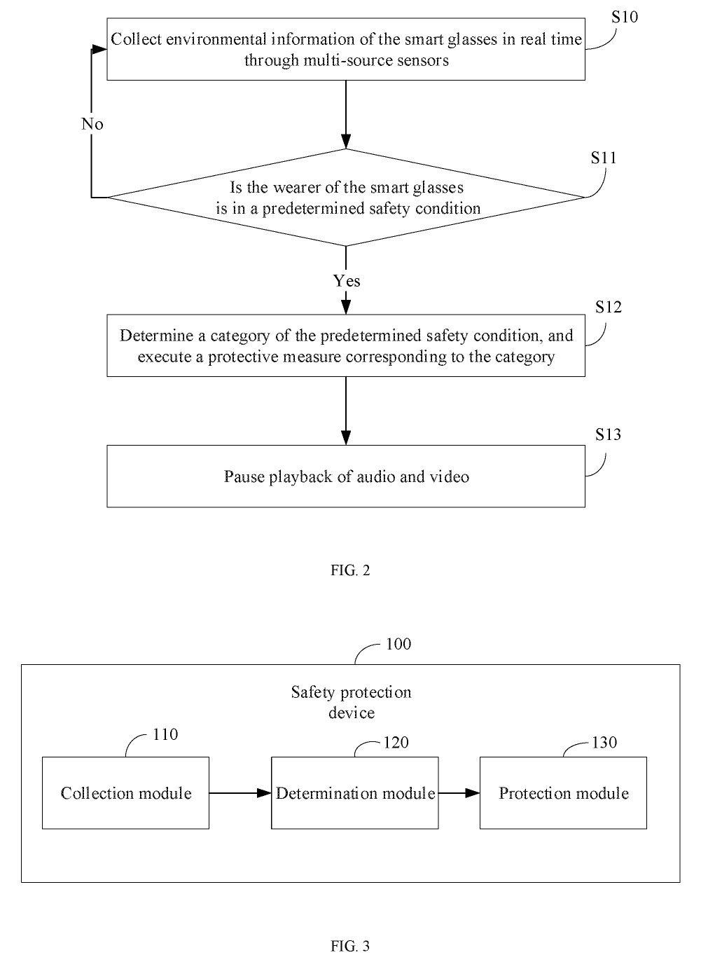

Please refer to FIG. 2, which is a flowchart of a safety protection method according to an embodiment of the present application.

The safety protection method of this embodiment is applied to an electronic device, for example, the electronic device 10 of the smart glasses 1 shown in FIG. 1. Specifically, the safety protection method includes following blocks. According to different requirements, an order of some blocks in the flowchart may be changed, and some blocks may be omitted.

Block S10, environmental information of the smart glasses is collected in real time through multi-source sensors.

In some embodiments of the present application, the smart glasses include the electronic device and the multi-source sensors. The electronic device is in communication connection with the multi-source sensors. The multi-source sensors may include, but are not limited to, a microphone, a camera, a lidar, an IMU, etc.

In some embodiments of the present application, the environmental information includes, but is not limited to, audio data collected by the microphone, image data collected by the camera, 3D point cloud data collected by the lidar, and motion state data of an object (e.g., the wearer of the smart glasses) calculated based on an acceleration and an angular velocity of the object measured by the IMU. In some embodiments of the present application, the calculating of the motion state data of the object is performed by the IMU. In other embodiments, the calculating of the motion state data of the object is performed by a processor of the electronic device.

Block S11, whether the wearer of the smart glasses is in a predetermined safety condition is determined based on the environmental information.

In some embodiments of the present application, determining whether the wearer of the smart glasses is in a predetermined safety condition based on the environmental information includes: converting the audio data into text information based on a preset speech recognition technology, and measuring a volume value of the audio data; if the text information includes a preset keyword and/or the volume value is greater than a preset volume threshold, determining that the wearer is in a predetermined safety condition.

Specifically, the electronic device converts the audio data into text information based on speech recognition technology. The speech recognition technology is a technology that converts audio data into text information, which can be implemented through following blocks: converting the audio data into digital signals; preprocessing the audio data, including removing noise from the audio data, enhancing speech signals of the audio data, etc., to improve an accuracy of a speech recognition; then extracting feature parameters from the preprocessed audio data, such as mel-frequency cepstral coefficients (MFCC), linear predictive cepstral coefficients (LPCC), etc.; matching the feature parameters with a pre-established speech model to determine the most likely text information, and obtaining a recognition result, where the speech model may be a hidden Markov model (HMM), a dynamic time warping (DTW), etc.; finally, using the speech model to further optimize and correct the recognition result, ensuring that the recognized text information conforms to grammatical rules and semantic logic of natural language.

Furthermore, when the text information corresponding to the audio data includes a preset keyword, such as "danger", "caution", etc., and/or the volume value is greater than a preset volume threshold, for example, 80 decibels, the electronic device 10 determines that the wearer is in a predetermined safety condition.

In some embodiments of the present application, determining whether the wearer of the smart glasses is in a predetermined safety condition based on the environmental information further includes: detecting a moving object in the image data based on a preset object perception algorithm; determining a separation distance between the moving object and the smart glasses based on the 3D point cloud data; if the separation distance is less than a preset distance threshold, determining that the wearer is in a predetermined safety condition.

Specifically, the image data around the wearer is collected in real time through the camera. These image data can reflect a situation of a moving object in the environment, such as pedestrians, vehicles, etc. The 3D point cloud data is collected through the lidar 40. The 3D point cloud data includes depth information and spatial structure of the environment, which can accurately describe a position, a shape, and a distance of each object from the wearer. Further, the electronic device preprocesses the image data and the 3D point cloud data, including removing noise, data enhancement, etc., to improve quality and reliability of the image data and the 3D point cloud data, and prepare for subsequent processing by the object perception algorithm; based on the object perception algorithm, analyzing the image data to detect the moving object in the image data, where the object perception algorithm can be a target detection model based on machine learning or deep learning, which can identify and locate the moving object in the image, such as pedestrians, vehicles, etc.; based on position information of the moving object in the 3D point cloud data, the separation distance between the moving object and the smart glasses is calculated, specifically, the separation distance between the moving object and the smart glasses in space can be determined through coordinate information and depth information of the moving object in the point cloud data; finally, the separation distance is compared with a preset distance threshold. If the separation distance is less than the preset distance threshold, for example, 1 meter, the electronic device determines that the moving object is too close to the wearer, which may pose a threat to the wearer's safety, for example, the moving object may cause a collision, an interference, and other safety issues to the wearer, and thus the electronic device determines that the wearer is in a predetermined safety condition.

In some embodiments of the present application, determining whether the wearer of the smart glasses is in a predetermined safety condition based on the environmental information further includes: determining, based on the object perception algorithm and by combining the image data and the 3D point cloud data, whether the ground on which the wearer is walking has preset hazardous terrain; if the ground on which the wearer is walking has hazardous terrain, determining that the wearer is in a predetermined safety condition, and determining that a category of the predetermined safety condition is a first preset category.

Specifically, the image data may include two-dimensional color images or two-dimensional grayscale images, which can reflect visual characteristics of the ground, such as a color, a texture, etc. The 3D point cloud data may include depth information and spatial structure of the ground, which may accurately describe a geometric shape and undulations of the ground.

Further, the electronic device performs preprocessing (such as noise removal, data augmentation, etc.) on the image data and the 3D point cloud data to improve data quality and reliability. Subsequently, the electronic device performs feature extraction and fusion, which includes: extracting two-dimensional (2D) visual features (e.g., color, texture) from the preprocessed image data and simultaneously extracting 3D spatial features (e.g., depth, shape) from the preprocessed 3D point cloud data; and fusing the 2D visual features and 3D spatial features to generate a unified fused feature vector that provides a more comprehensive description of ground attributes. Furthermore, the electronic device computes and derives physical terrain characteristics of the ground, such as flatness, slope, and undulation, from the fused feature vector. Finally, the electronic device uses an object perception algorithm to analyze the physical terrain characteristics. The object perception algorithm employs a machine learning model or a deep learning model to classify and determine whether hazardous terrain (e.g., stairs, high platforms, deep pits, steep slopes) is present on the ground by matching and comparing the real-time extracted physical terrain characteristics against a preset library of hazardous terrain features.

In some embodiments of the present application, determining whether the wearer of the smart glasses is in a predetermined safety condition based on the environmental information further includes: detecting whether a preset keyword is in the image data based on a preset target detection algorithm; if the keywords is in the image data, determining that the wearer is in a predetermined safety condition.

Specifically, the image data around the wearer is collected in real time through the camera. These image data can reflect objects, scenes, and possible keyword information in the environment.

Further, the electronic device performs preprocessing (such as adjusting image brightness and contrast, etc) on the image data, , to improve data quality and reliability, preparing for subsequent processing by a preset target detection algorithm; then, based on the target detection algorithm, analyzing the preprocessed image data to detect whether a preset keyword is in the image data, where the preset keyword may be a word indicating danger, warning, prohibition, etc., such as "caution", "attention", "danger", "no entry", "high voltage danger", etc. The target detection algorithm can be a text detection model based on machine learning or deep learning, which can identify and locate text information in the image and determining whether the text information matches a preset keyword; if the target detection algorithm detects the preset keyword in the image data, the electronic device determines that the wearer of the smart glasses is in a predetermined safety condition. The preset keyword may be "danger" or "no entry" may mean that the wearer is approaching a dangerous area or a prohibited area. In other embodiments, the text information may be matched with a preset keyword library to determine whether a preset keyword is in the image data.

In some embodiments of the present application, determining whether the wearer of the smart glasses is in a predetermined safety condition based on the environmental information further includes: determining a changed amplitude and a changed speed of a movement direction of the wearer based on the motion state data; if the changed amplitude is greater than a preset amplitude threshold and/or the changed speed is greater than a preset speed threshold, determining that the wearer is in a predetermined safety condition.

Specifically, the motion state data of the wearer is collected in real time through the IMU. The motion state data can reflect the wearer's movement direction, speed, acceleration, etc.

Further, the electronic device performs preprocessing (such as removing noise, data smoothing) on the motion state data, to improve data accuracy and reliability, preparing for subsequent analysis and processing; then, based on the preprocessed motion state data, calculating the changed amplitude of the wearer's movement direction, which can be achieved by analyzing changes in acceleration or angular velocity, for example, calculating a change angle of the movement direction within a certain time interval. At the same time, based on the preprocessed motion state data, the electronic device calculates the changed speed of the wearer's movement direction, that is, a rate of change of the movement direction, which can be calculated by a ratio of the changed amplitude of the movement direction to a corresponding time interval; then, the electronic device compares the changed amplitude with a preset amplitude threshold, and compares the changed speed with a preset speed threshold; finally, if the changed amplitude is greater than the preset amplitude threshold and/or the changed speed is greater than the preset speed threshold, the electronic device determines that the wearer of the smart glasses is in a predetermined safety condition. As the changed amplitude being greater than the preset amplitude threshold and/or the changed speed being greater than the preset speed threshold indicates that the wearer's motion state has changed drastically, and may face potential safety risks, for example, the wearer may be in situations such as quick turning, sudden stop, or loss of balance, which may easily cause falls, collisions, and other safety accidents.

In some embodiments of the present application, if the wearer is in the predetermined safety condition, the electronic device 10 continues to execute block S12; otherwise, if the wearer does not is in the predetermined safety condition, the electronic device 10 returns to execute block S10.

Block S12, a category of the predetermined safety condition is determined, and a protective measure corresponding to the category is performed.

In some embodiments of the present application, if position information of a sound source relative to the wearer has been determined based on the audio data, the category of the predetermined safety condition is determined as a first preset category; if the position information of the sound source relative to the wearer cannot be determined based on the audio data, the category of the predetermined safety condition is determined as a second preset category.

Specifically, the electronic device can use sound source localization technology to determine whether the position information of the sound source relative to the wearer can be determined based on the audio data, for example, by analyzing a time difference, a phase difference, etc. of sound waves arriving at different microphones in the audio data to determine a direction and a distance of the sound source. If the position information of the sound source can be successfully determined, the electronic device determines that the risk comes from a specified direction and position, then the electronic device 10 determines the category of the predetermined safety condition as the first preset category; conversely, if the position information of the sound source cannot be determined, the electronic device determines that the risk may come from any direction or position, and the category is determined as the second preset category.

In some embodiments of the present application, if the separation distance between the moving object and the smart glasses is less than the preset distance threshold, the category is determined as the first preset category.

In some embodiments of the present application, if the ground on which the wearer is walking has hazardous terrain, the category is determined as the first preset category.

In some embodiments of the present application, if the preset keyword is in the image data, the category is determined as the second preset category.

In some embodiments of the present application, if the changed amplitude is greater than the preset amplitude threshold and/or the changed speed is greater than the preset speed threshold, the category is determined as the second preset category.

In some embodiments of the present application, if the category of the predetermined safety condition is the first preset category, the electronic device turns off a local tinting mode of a preset electrochromic lens of the smart glasses, and turns on a local transparent mode of the preset electrochromic lens.

Specifically, the local tinting mode refers to changing optical characteristics of a specific area of the electrochromic lens from transparent to opaque or tinted through electrochromic technology according to a preset tinting area and a preset tinting degree. A shape and a position of a tinting area can be dynamically adjusted according to the direction and position of the risk source. For example, if the risk comes from a left side of the wearer, the electronic device turns off the local tinting mode of a left electrochromic lens to guide the wearer's attention to focus on a potential risk area, avoiding ignoring important risks due to a distracted field of vision. The local transparent mode refers to increasing transparency of a specified area of the electrochromic lens by adjusting a voltage or current of electrochromic material of the electrochromic lens, forming a local high-transparency window. This high-transparency window can provide a clearer field of view, helping the wearer better observe details of the risk area, such as dynamics of moving objects, a specific situation of hazardous terrain, etc.

In some embodiments of the present application, if the category of the predetermined safety condition is the second preset category, the electronic device turns off a global tinting mode of the preset electrochromic lens, and turns on a global transparent mode of the preset electrochromic lens.

Specifically, after the electronic device turns off the global tinting mode, the electrochromic material of the electrochromic lens gradually returns to an initial transparent state under action of a control circuit, eliminating any previously existing local tinting areas, making the lens uniformly transparent. After the smart glasses turn on the global transparent mode, by adjusting driving parameters of the electrochromic material, the electrochromic lens remains globally transparent, ensuring that the wearer can obtain a clearer and unobstructed field of view.

Block S13, the smart glasses is controlled to pause playback of audio and video.

In some embodiments of the present application, audio and video may include, but are not limited to, music, movies, etc.

In the safety protection method of this embodiment, first, environmental information of the smart glasses is collected in real time through multi-source sensors; second, whether the wearer of the smart glasses is in a predetermined safety condition is determined based on the environmental information; finally, if the wearer is in the predetermined safety condition, the category of the predetermined safety condition is determined, and the protective measure corresponding to the category is executed. Based on this, the present application uses multi-sensor fusion technology to monitor environmental changes in real time, which can improve the user's perception ability of the real environment, and trigger protective measure in advance before danger occurs, avoiding potential safety risks in dynamic scenes, enabling the smart glasses to achieve danger prediction and intervention while ensuring an immersive experience, and improving the safety and practicality of the smart glasses.

In some embodiments of the present application, after pausing playback of audio and video, the safety protection method further includes: if the electronic device detects that the user has taken off the smart glasses within a first preset time period (for example, 2 minutes), and subsequently puts on the smart glasses, the electronic device restores a usage state of the smart glasses to a state before the predetermined safety condition is determined, and continues to play audio and video.

In the above embodiment, when the electronic device detects a specified operation of the user, the electronic device restores to the usage state before the predetermined safety condition is determined, improving the practicality and flexibility of the smart glasses, thereby enhancing the user experience.

In some embodiments of the present application, after pausing playback of audio and video, the safety protection method further includes: if the electronic device detects that the user clicks a specified switch button on the smart glasses within a second preset time period (for example, 2 minutes), the electronic device returns to execute block S10, and continues playing audio and video.

In some embodiments of the present application, after pausing playback of audio and video, the safety protection method further includes: if the electronic device detects that the user has no response within a third preset time period (for example, 2 minutes) and/or the IMU senses predetermined signals such as the smart glasses being impacted or falling, the electronic device sends a distress signal to a service center, and the service center makes a distress call. The user can click a specified switch button to cancel the distress call at any time.

In the above embodiment, when the electronic device detects that the user has no response within a third preset time period (for example, 2 minutes) and/or the IMU senses predetermined signals such as the smart glasses being impacted or falling, the electronic device sends a distress signal to the service center, and the service center makes a distress call, which can take an emergency rescue measure when the user has an accident, enhancing the safety of using the smart glasses.

Please refer to FIG. 3, which is a functional block diagram of a safety protection device according to an embodiment of the present application.

In this embodiment, based on the same concept as the safety protection method in the above embodiment shown in FIG. 3, the present application further provides a safety protection device 100, which can be used to execute the above safety protection method. For ease of description, in the composition diagram of the embodiment of the safety protection device 100, only parts related to the embodiment of the present application are shown. Those skilled in the art can understand that the illustrated structure does not constitute a limitation to the safety protection device 100, and may include more or fewer components than those shown, or combine some components, or have different component arrangements.

Specifically, the safety protection device 100 provided by the embodiment of the present application includes a collection module 110, a determination module 120, and a protection module 130.

The collection module 110 is used to collect environmental information of the smart glasses in real time through multi-source sensors.

In some embodiments of the present application, the environmental information includes, but is not limited to, audio data, image data, 3D point cloud data, and motion state data of the wearer of the smart glasses.

The determination module 120 is used to determine whether the wearer of the smart glasses is in a predetermined safety condition based on the environmental information.

The protection module 130 is used to, if the wearer is in the predetermined safety condition, determine a category of the predetermined safety condition, and execute a protective measure corresponding to the category.

In the safety protection device 100 of this embodiment, first, environmental information of the smart glasses is collected in real time through multi-source sensors; second, whether the wearer of the smart glasses is in the predetermined safety condition is determined based on the environmental information; finally, if the wearer is in the predetermined safety condition, the category of the predetermined safety condition is determined, and the protective measure corresponding to the category is executed. Based on this, the present application uses multi-sensor fusion technology to monitor environmental changes in real time, which can improve the user's perception ability of the real environment, and trigger the protective measure in advance before danger occurs, avoiding potential safety risks in dynamic scenes, enabling the smart glasses to achieve danger prediction and intervention while ensuring an immersive experience, and improving the safety and practicality of the smart glasses .

With reference to FIG. 1, in some embodiments of the present application, the electronic device 10 includes, but is not limited to, a storage device 11, a processor 12, and a computer program stored in the storage device 11 and executable on the processor 12, such as a safety protection program. When the computer program is executed by the processor 12, the safety protection method according to the above embodiments is implemented.

FIG. 1 only shows the electronic device 10 with the storage device 11 and the processor 12. Those skilled in the art can understand that the structure shown in FIG. 1 does not constitute a limitation to the electronic device 10, and may include fewer or more components than those shown, or combine some components, or have different component arrangements.

The storage device 11 in the electronic device 10 stores multiple computer-readable instructions to implement the safety protection method. The processor 12 can execute multiple instructions to thereby: collect environmental information of the smart glasses 1 in real time through multi-source sensors; judge whether the wearer of the smart glasses 1 is in a predetermined safety condition based on the environmental information; if the wearer is in the predetermined safety condition, determine a category of the predetermined safety condition, and execute a protective measure corresponding to the category.

Specifically, for the specific implementation method of the above instructions by the processor 12, reference may be made to the description of related blocks in the corresponding embodiment of FIG. 2, which will not be repeated here.

Those skilled in the art can understand that the schematic diagram is only an example of the electronic device 10 and does not constitute a limitation to the electronic device 10. The electronic device 10 may be a bus structure or a star structure. The electronic device 10 may also include other hardware or software that are more or less than those shown, or have different component arrangements. For example, the electronic device 10 may also include input/output devices, network access devices, etc.

It should be noted that the electronic device 10 is only an example. Other existing or future electronic products that may be adapted to the present application should also be included within the protection scope of the present application and are incorporated herein by reference.

The storage device 11 includes at least one type of computer-readable storage medium. The computer-readable storage medium may be non-volatile or volatile. The computer-readable storage medium includes flash memory, mobile hard disk, multimedia card, card-type storage device (such as secure digital memory card, xD-Picture card, etc.), magnetic storage device, magnetic disk, optical disk, etc. In some embodiments, the storage device 11 may be an internal storage unit of the electronic device 10, such as a mobile hard disk of the electronic device 10. In other embodiments, the storage device 11 may also be an external storage device of the electronic device 10, such as a plug-in mobile hard disk, a smart media card (SMC), a secure digital (SD) card, a flash card, etc. equipped on the electronic device 10. The storage device 11 can not only be used to store application software and various data installed on the electronic device 10, such as the code of a safety protection program, but also used to temporarily store data that has been output or is to be output.

In some embodiments, the processor 12 may be composed of integrated circuits, for example, it may be composed of a single packaged integrated circuit or multiple integrated circuits with the same or different functions packaged together, including one or more central processing units (CPU), microprocessors, digital processing chips, graphics processors, and combinations of various control chips, etc. The processor 12 is the control core of the electronic device 10, connecting various components of the entire electronic device 10 through various interfaces and lines, by running or executing programs or modules stored in the storage device 11 (such as executing a safety protection program, etc.), and invoking data stored in the storage device 11, to execute various functions of the electronic device 10 and process data.

The processor 12 executes an operating system of the electronic device 10 and executes various applications installed in the electronic device 10. The processor 12 executes applications to implement the blocks in the various embodiments of the safety protection method.

For example, the computer program may be divided into one or more modules/units, and the one or more modules/units are stored in the storage device 11 and executed by the processor 12 to complete the present application. The one or more modules/units may be a series of computer-readable instruction segments capable of completing specific functions, and the instruction segments are used to describe the execution process of the computer program in the electronic device 10.

The integrated units implemented in the form of software functional modules may be stored in a computer-readable storage medium. The above software functional modules are stored in a storage medium, including several instructions to cause a computer device (which may be a personal computer, computer device, or network device, etc.) or processor 12 to execute part of the safety protection method of the various embodiments of the present application.

If the modules/units integrated in the electronic device 10 are implemented in the form of software functional units and sold or used as independent products, they may be stored in a computer-readable storage medium. Based on this understanding, the present application implements all or part of the processes in the above method embodiments, and may also be completed by instructing relevant hardware devices through a computer program. The computer program may be stored in a computer-readable storage medium, and when the computer program is executed by the processor 12, the blocks of the various method embodiments may be implemented.

The computer program includes computer program code, which may be in the form of source code, object code, executable file, or some intermediate form, etc. The computer-readable medium may include: any entity or device capable of carrying the computer program code, recording medium, U disk, mobile hard disk, magnetic disk, optical disk, computer memory, read-only memory (ROM), random access memory, and other memories.

Furthermore, the computer-readable storage medium may mainly include a storage program area and a storage data area, where the storage program area may store an operating system, application programs required for at least one function, etc.; the storage data area may store data created according to the use of blockchain nodes, etc.

The bus may be a peripheral component interconnect (PCI) bus or an extended industry standard architecture (EISA) bus, etc. The bus may be divided into an address bus, a data bus, a control bus, etc. For ease of representation, only one arrow is used in FIG. 1, but it does not mean that there is only one bus or one type of bus. The bus is set to achieve connection and communication between the storage device 11 and at least one processor 12, etc.

The embodiment of the present application further provides a computer-readable storage medium (not shown in the figure). The computer-readable storage medium stores computer-readable instructions, and the computer-readable instructions are executed by the processor 12 in the electronic device 10 to implement the safety protection method according to any of the above embodiments.

In the several embodiments provided by the present application, it should be understood that the disclosed system, device, and method may be implemented in other ways. For example, the device embodiments described above are only schematic. For example, the division of modules is only a logical function division, and there may be other division methods in actual implementation.

The modules described as separate components may or may not be physically separated, and the components displayed as modules may or may not be physical units, that is, they may be located in one place, or may be distributed to multiple network units. Some or all of the modules may be selected according to actual needs to achieve the objectives of the solutions of the embodiments.

In addition, the various functional modules in the various embodiments of the present application may be integrated into one processing unit, or each unit may exist physically separately, or two or more units may be integrated into one unit. The above integrated units may be implemented in the form of hardware, or in the form of hardware plus software functional modules.

Furthermore, obviously, the term "include" does not exclude other units or blocks, and the singular does not exclude the plural. Multiple units or devices described in the specification may also be implemented by one unit or device through software or hardware. The terms "first", "second", etc. are used to denote names and do not indicate any particular order.

Finally, it should be noted that the above embodiments are only used to illustrate the technical solutions of the present application and not to limit them. Although the present application has been described in detail with reference to the preferred embodiments, those of ordinary skill in the art should understand that they can modify or equivalently replace the technical solutions of the present application without departing from the spirit and scope of the technical solutions of the present application.

What is claimed is:

1. A safety protection method, comprising:
collecting environmental information of smart glasses through multi-source sensors of the smart glasses;
determining whether a wearer of the smart glasses is in a predetermined safety condition based on the environmental information; and
in response that the wearer is in the predetermined safety condition, determining a category of the predetermined safety condition, and executing a protective measure corresponding to the category.

2. The safety protection method according to claim 1, wherein the environmental information comprises audio data;
wherein determining whether the wearer is in the predetermined safety condition based on the environmental information comprises: converting the audio data into text information, and measuring a volume value of the audio data; in response to the text information including a preset keyword and/or the volume value being greater than a preset volume threshold, determining that the wearer is in the predetermined safety condition;
wherein determining the category of the predetermined safety condition comprises: in response to position information of a sound source relative to the wearer having been determined based on the audio data, determining that the category is a first preset category; in response to the position information cannot be determined based on the audio data, determining that the category is a second preset category.

3. The safety protection method according to claim 1, wherein the environmental information comprises image data and 3D point cloud data;
wherein determining whether the wearer of the smart glasses is in the predetermined safety condition based on the environmental information comprises: detecting a moving object in the image data based on a preset object perception algorithm; determining a separation distance between the moving object and the smart glasses based on the 3D point cloud data; in response to the separation distance being less than a preset distance threshold, determining that the wearer is in the predetermined safety condition;
wherein determining the category of the predetermined safety condition comprises: determining that the category is a first preset category.

4. The safety protection method according to claim 1, wherein the environmental information comprises image data and three-dimensional (3D) point cloud data;
wherein determining whether the wearer of the smart glasses is in the predetermined safety condition based on the environmental information comprises: based on a preset object perception algorithm and a combination of the image data and the 3D point cloud data, determining whether ground on which the wearer is walking has preset hazardous terrain; in response to the ground having the preset hazardous terrain, determining that the wearer is in the predetermined safety condition;
wherein determining the category of the predetermined safety condition comprises: determining that the category is a first preset category.

5. The safety protection method according to claim 1, wherein the environmental information comprises image data;
wherein determining whether the wearer of the smart glasses is in the predetermined safety condition based on the environmental information comprises: detecting whether a preset keyword is in the image data based on a preset target detection algorithm; in response that the preset keyword is in the image data, determining that the wearer is in the predetermined safety condition;
wherein determining the category of the predetermined safety condition comprises: determining that the category is a second preset category.

6. The safety protection method according to claim 1, wherein the environmental information comprises motion state data of the wearer;
wherein determining whether the wearer of the smart glasses is in the predetermined safety condition based on the environmental information comprises: determining a changed amplitude and a changed speed of a movement direction of the wearer based on the motion state data; in response to the changed amplitude being greater than a preset amplitude threshold and/or the changed speed being greater than a preset speed threshold, determining that the wearer is in the predetermined safety condition;
wherein determining the category of the predetermined safety condition comprises: determining that the category is a second preset category.

7. The safety protection method according to claim 1, wherein the smart glasses further comprise electrochromic lenses, and the executing of the protective measure corresponding to the category comprises:
in response to the category being a first preset category, turning off a local tinting mode of the electrochromic lenses, and turning on a local transparent mode of the electrochromic lenses;
in response to the category being a second preset category, turning off a global tinting mode of the electrochromic lenses, and turning on a global transparent mode of the electrochromic lenses.

8. The safety protection method according to claim 1, further comprising:
pausing playback of audio and video after executing the protective measure corresponding to the category.

9. An electronic device, comprising
a storage device stored with a computer program; and
at least one processor; wherein when the computer program is executed by the at least one processor, the at least one processor is caused to:
collect environmental information of smart glasses through multi-source sensors of the smart glasses;
determine whether a wearer of the smart glasses is in a predetermined safety condition based on the environmental information; and
in response to the wearer being in the predetermined safety condition, determine a category of the predetermined safety condition, and execute a protective measure corresponding to the category.

10. The electronic device according to claim 9, wherein the environmental information comprises audio data;
wherein the at least one processor determines whether the wearer is in the predetermined safety condition based on the environmental information by: converting the audio data into text information, and measuring a volume value of the audio data; in response to the text information including a preset keyword and/or the volume value being greater than a preset volume threshold, determining that the wearer is in the predetermined safety condition;
wherein the at least one processor determines the category of the predetermined safety condition by: in response to position information of a sound source relative to the wearer having been determined based on the audio data, determining that the category is a first preset category; in response to the position information cannot be determined based on the audio data, determining that the category is a second preset category.

11. The electronic device according to claim 9, wherein the environmental information comprises image data and three-dimensional (3D) point cloud data;
wherein the at least one processor determines whether the wearer of the smart glasses is in the predetermined safety condition based on the environmental information by: detecting a moving object in the image data based on a preset object perception algorithm; determining a separation distance between the moving object and the smart glasses based on the 3D point cloud data; in response to the separation distance being less than a preset distance threshold, determining that the wearer is in the predetermined safety condition;
wherein the at least one processor determines the category of the predetermined safety condition by: determining that the category is a first preset category.

12. The electronic device according to claim 9, wherein the environmental information comprises image data and 3D point cloud data;
wherein the at least one processor determines whether the wearer of the smart glasses is in the predetermined safety condition based on the environmental information by: determining, based on a preset object perception algorithm and by combining the image data and the 3D point cloud data, whether ground on which the wearer is walking has preset hazardous terrain; in response to the ground having the preset hazardous terrain, determining that the wearer is in the predetermined safety condition;
wherein the at least one processor determines the category of the predetermined safety condition by: determining that the category is a first preset category.

13. The electronic device according to claim 9, wherein the environmental information comprises image data;
wherein the at least one processor determines whether the wearer of the smart glasses is in the predetermined safety condition based on the environmental information by: detecting whether a preset keyword is in the image data based on a preset target detection algorithm; in response that the preset keyword is in the image data, determining that the wearer is in the predetermined safety condition;
wherein the at least one processor determines the category of the predetermined safety condition by: determining that the category is a second preset category.

14. The electronic device according to claim 9, wherein the environmental information comprises motion state data of the wearer;
wherein the at least one processor determines whether the wearer of the smart glasses is in the predetermined safety condition based on the environmental information by: determining a changed amplitude and a changed speed of a movement direction of the wearer based on the motion state data; in response to the changed amplitude being greater than a preset amplitude threshold and/or the changed speed being greater than a preset speed threshold, determining that the wearer is in the predetermined safety condition;
wherein the at least one processor determines the category of the predetermined safety condition by: determining that the category is a second preset category.

15. The electronic device according to claim 9, wherein the smart glasses further comprise electrochromic lenses, and the at least one processor executes the protective measure corresponding to the category by:
in response to the category being a first preset category, turning off a local tinting mode of the electrochromic lenses, and turning on a local transparent mode of the electrochromic lenses;
in response to the category being a second preset category, turning off a global tinting mode of the electrochromic lenses, and turning on a global transparent mode of the electrochromic lenses.

16. The electronic device according to claim 9, wherein the at least one processor is further caused to
pause playback of audio and video after executing the protective measure corresponding to the category.

17. Smart glasses, wherein the smart glasses comprise the electronic device according to claim 10.
